(19) United States
(12) Patent Application Publication
(10) Pub. No.: US 2004/0017857 A1
(43) Pub. Date: Jan. 29, 2004

(54) Transmitter, receiver, methods, program and signal adapted to modulations having a large number of states

(76) Inventors: Antoine Chouly, Paris (FR); Olivier Pothier, Paris (FR)

Correspondence Address: PHILIPS INTELLECTUAL PROPERTY & STANDARDS, P.O. BOX 3001, BRIARCLIFF MANOR, NY, 10510, US

(21) Appl. No.: 10/206,028

(22) Filed: Jul. 26, 2002

(51) Int. Cl. H04L 5/12

(52) U.S. Cl. 375/295; 375/316

(57) ABSTRACT

The invention relates to an encoding/decoding method associating the modulation/demodulation with the channel encoding/decoding operation so as to improve the performances at the decoding level in the case of a modulation having a large number of states. The iterative decoding method involves a pair of SISO decoders receiving, at their inputs, probability information components for symbols so as to supply, at the output, a posteriori probability information components for the transmitted information symbols. Application: Digital telecommunication.

The invention relates to a transmitter comprising channel encoding and modulation means for transforming a binary data stream into wave signals represented by symbols to be transmitted and intended to transport said binary data in a transmission channel, said wave signals being selected in a constellation having M states.

The invention also relates to a receiver comprising iterative demodulation and channel decoding means for recovering, from received signals, information symbols selected in an alphabet having M states.

The invention also relates to a method of channel encoding and modulation for transforming a binary data stream into wave signals represented by symbols to be transmitted and intended for transporting said binary data in a transmission channel, said wave signals being selected in a constellation having M states.

The invention also relates to a method of demodulation and channel decoding for recovering, from received signals, transmitted information symbols selected in an alphabet having M states.

The invention finally relates to computer programs for performing the methods described above and to a signal for transporting said computer programs.

The invention finds numerous applications, particularly in the field of digital video transmission by satellite, wireless network systems and mobile radio telecommunication systems.

The article by S. Le Goff, A. Glavieux and C. Berrou entitled “Turbo-codes and high spectral efficiency modulation” published during the International Conference on Communication, 1994, pp. 645-649 describes a channel encoding/decoding method applied to modulations having a large number of states, using the turbo-encoding principle as described by C. Berrou, A. Glavieux and P. Thitimajshima in the article entitled “Near Shannon limit error-correcting coding and decoding: Turbo-codes” published at the International Conference on Communication, 1993, pp. 1064-1070,. In accordance with this method of the pragmatic type, the channel decoding comprises a preliminary step of computing probabilities for each bit of each received symbol such that the channel decoding is subsequently performed similarly as in the binary case, i.e. the decoders of the type receiving and supplying probability indications, also referred to as SISO (Soft Input Soft Output) receive, at their inputs, probabilities for constituent binary data of the received symbols. At the decoding level, this method is not optimal because the binary data at the inputs of the SISO decoders belonging to the same symbol to be transmitted are not independent, which reduces the decoding performance to a considerable extent.

It is an object of the invention to provide channel encoding and decoding means adapted to modulations having a large number of states and allowing improvement of the performances at the channel decoding level.

To this end, a transmitter of the type described in the opening paragraph is provided, which is characterized in that said channel encoding and modulation means comprise:

conversion means upstream for converting said binary data stream into a stream of information symbols, referred to as input stream, such that the number of possible information symbols is equal to the number M of signals of said constellation,

interleaving means for interleaving said information symbols of the input stream and generating a stream of interleaved information symbols, referred to as interleaved input stream,

at least a first and a second coder operating in parallel for receiving said input stream and said interleaved input stream, respectively, for supplying output streams comprising:

I. indications relating to said information symbols and first redundancy information components introduced by the first coder, and

II. second redundancy information components introduced by the second coder,

selection means for determining, from said output streams, said wave signals to be transmitted.

At the transmitter end, the binary data stream to be transmitted is transformed into symbols selected from an alphabet having the same size as the size of the constellation used for the modulation. The channel coder thus receives information symbols instead of binary data at its input. Advantageously, the determination of symbols to be transmitted is immediate, starting from input symbols selected from an alphabet having the same cardinal number as the constellation used for the modulation.

A receiver of the type described in the opening paragraph is also provided, which is characterized in that said iterative demodulation and channel decoding means comprise:

reception means for receiving said signals and converting them into data symbols, referred to as received symbols,

probability computation means for supplying probability vectors comprising, for each received symbol, probability indications relating to said information symbols and probability indications relating to redundancy indications supplied by a coder at the transmitting end from said information symbols,

a sequence of decoders, referred to as SISO decoders, operating in successive pairs and receiving, at the input, at least:

i. said probability vectors, and

ii. independent indications of the received symbols related to the information symbols, referred to as a priori information components,

for supplying, at the output, at least:

iii. results related to the information symbols, referred to as extrinsic information components, and

iv. a posteriori probability indications for the information symbols, referred to as a posteriori information components,

at least a decision block for selecting said information symbols from said a posteriori information components.

In this way, the symbols at the inputs of the SISO decoders are mutually independent, which improves the decoding efficiency.

These and other aspects of the invention are apparent from and will be elucidated, by way of non-limitative example, with reference to the embodiment(s) described hereinafter.

In the drawings:

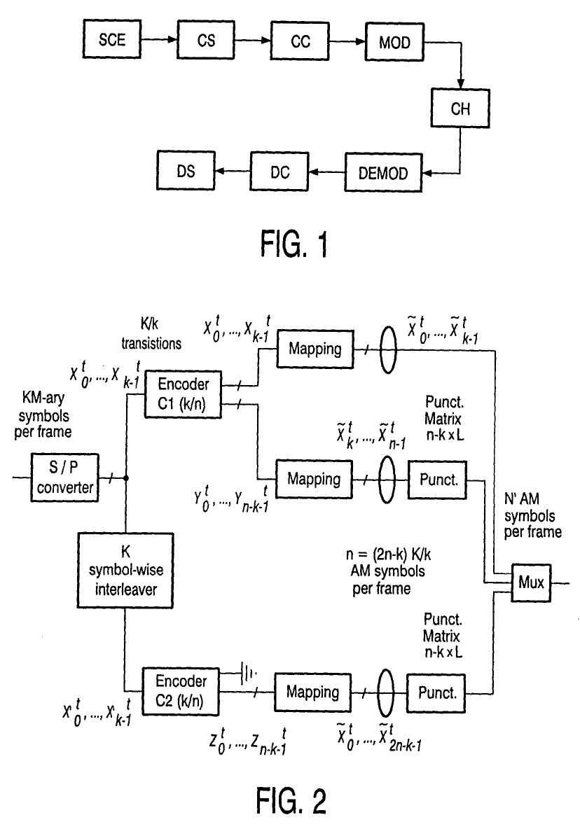

FIG. 1 is a block diagram illustrating an example of a conventional transmission system,

FIG. 2 is a block diagram illustrating an example of a transmitter according to the invention,

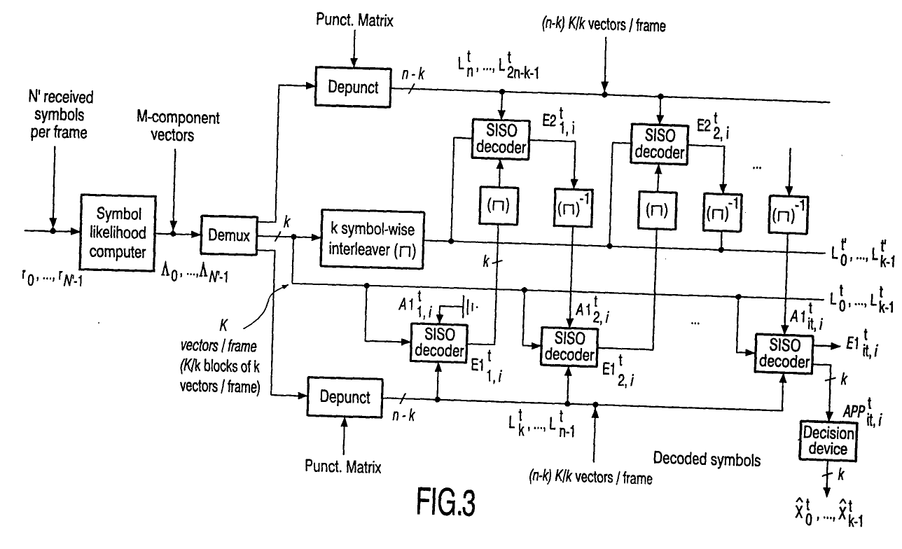

FIG. 3 is a block diagram illustrating an example of a receiver according to the invention,

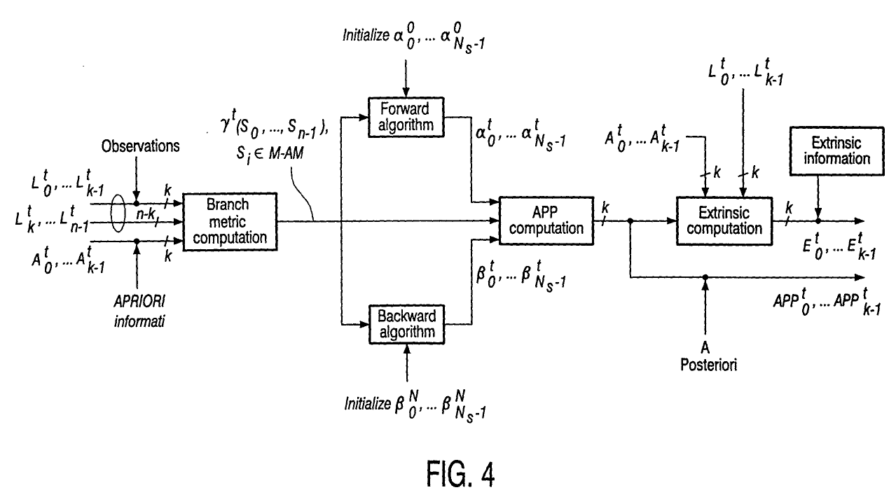

FIG. 4 is a block diagram illustrating an embodiment of a SISO decoder according to the invention.

FIG. 1 is a block diagram illustrating an example of a conventional transmission system. It comprises a transmitter realizing a transmission chain, a receiver realizing a reception chain and a transmission channel. The transmitter and the receiver communicate via the transmission channel, while the transmission chain comprises:

a source SCE for supplying a source signal which may be an analog signal, such as an audio or video or digital signal, or the output of a fax apparatus, but which must in any way be converted in digital transmission systems into a sequence of binary data,

a source coder CS for reducing the quantity of binary data to be transmitted through the channel and supplying a sequence of binary information components intended for a channel coder,

a channel coder CC for introducing the redundancy in the sequence of binary information components to be transmitted through the channel with a view to protecting it against transmission errors, which channel coder is characterized by its efficiency, denoted k/n with k<n, k representing the number of parallel binary data at the input of the coder and n representing the number of parallel binary data at the output of the coder, forming a sequence of n bits, also referred to as code word,

a modulator MOD for realizing the interface between the transmission channel and the transmitter by transforming the binary sequence or code word supplied by the channel coder into a single electric wave signal to be transmitted through the channel.

In an advantageous embodiment of the invention, the modulator is provided to transmit m information bits simultaneously by means of a constellation, referred to as M-ary, having M distinct states with M =2^{m}.

The transmission channel CH is a physical medium used for transmitting the wave signals from the transmitter to the receiver. It may be materialized in several manners: by air, in the case of wireless communication, by radio or satellite, by a cable in the case of a cable network, by optical fibers, etc.

The reception chain comprises:

a digital demodulator DEMOD for processing the received wave signals and converting them into sequences of figures representing estimations of the symbol of the transmitted M-ary constellation,

a channel decoder DC for reconstructing the sequence of original information components from the recovered symbol, knowing the encoding method used by the channel coder at the transmitter end, and finally

a source decoder DS for reconstructing the original binary signal, knowing the encoding method used by the source coder at the transmitter end.

The invention particularly relates to the channel encoding/decoding and modulation/demodulation parts. The conventional transmission chain is preserved, except at the transmitter end, where the channel encoding and the modulation are jointly realized by channel encoding and modulation means, and at the receiver end, where the channel decoding and demodulation are also jointly realized by channel decoding and demodulation means for optimizing the different successive processing operations. FIGS. 2 and 3 thus illustrate a transmitter and a receiver, respectively, according to the invention in which only the parts which differ from the conventional chain are shown.

In the following description, a single example of use of the invention will be described for reasons of conciseness. It relates to a particular amplitude modulation type having a number of distinct states equal to M, referred to as M-ary amplitude modulation, with M being an integer higher than 2, where M is generally a power of 2. Examples of this amplitude modulation type are the M-AM and M²-QAM modulations. However, the invention is also applicable to other modulations, notably of the PSK (Phase Shift Keying) type.

FIG. 2 shows an embodiment of a transmitter according to the invention for transforming a binary data stream into wave signals intended to transport said binary data in a transmission channel. The wave signals are represented by symbols to be transmitted, selected in a constellation of M states. Only the channel encoding and modulation means are shown in FIG. 2; the other parts of the transmission chain are identical to the conventional chain shown in FIG. 1.

The channel encoding and modulation means according to the invention comprise

conversion means upstream for converting said binary data stream into a stream of information symbols, referred to as input stream, such that the number of possible information symbols is equal to the number M of states of said constellation,

interleaving means for interleaving said information symbols of the input stream and generating a stream of interleaved information symbols, referred to as interleaved input stream,

a first and a second coder operating in parallel and receiving the input stream and the interleaved input stream, respectively, for supplying output streams comprising:

iii indications relating to the information symbols and first redundancy information components introduced by the first coder, and

iv. second redundancy information components introduced by the second coder,

selection means for determining, from the output streams, the wave signals to be transmitted,

optionally, marking means for adapting the efficiency of the channel coder to the rate desired at the output of the coder, consisting of suppressing data in the output streams,

an output multiplexer for multiplexing the different output streams in a single output stream to be transmitted through the channel.

In accordance with a preferred embodiment of the invention, the conversion means upstream comprise a correspondence table for converting a sequence of m bits in the binary data stream, with m=log₂(M) into an information symbol selected from the M possible information symbols. In the case of an amplitude modulation with 4 states, or 4-AM modulation, with M=4 and m=2, the symbols assume values in the set or constellation {−3, −1, 1, 3}. An example of a correspondence table is Table 1 which consists of a Gray encoding of the constellation. Other encoding types may of course also be used.

TABLE 1

| | | | |
|---|---|---|---|
| −3 | −1 | 1 | 3 |
| 00 | 01 | 10 | 11 |

The first and second coders are concatenated coders operating in parallel. These are systematic coders, i.e. of the type comprising an output reproducing the input data. Two coders are shown in FIG. 1, but the number of coders operating in parallel is not limited. Each coder is a systematic trellis coder for an M-ary modulation. Its input receives k information symbols in parallel, selected from a constellation of M states, denoted X^{t}=(X₀^{t}, . . . , Xₖ₋₁^{t}) and supplies at a first output the k input symbols X^{t}=(X₀^{t}, . . . , Xₖ₋₁^{t}) and, at a second output, the n-k redundancy symbols introduced by the coder, denoted Y^{t}=(Y₀^{t}, . . . , Yₙ₋ₖ₋₁^{t}). In accordance with the embodiment shown in FIG. 1, the coders have a coding efficiency, denoted k/n and k′/n, respectively, where k and k′ are integers representing a number of information symbols processed in parallel at the input of the coder, such that k=k′, and where n and n′ are integers representing encoded symbol numbers supplied in parallel at the output of the coder. The coder may consist of a conventional state machine receiving, at the input, k information symbols in parallel, associated with an M-ary alphabet [0, . . . , M−1]. Based on this input and on the current state of the state machine, a correspondence table selects the next state and the n-k M-ary redundancy symbols. The choice of the coder is not limited to the coders shown in a block diagram in the form of a specific shift register. The coders are preferably of the type having the property of tail-biting. The choice of the coder also depends on the modulation and the selection parameters for the wave signals to be transmitted through the channel.

FIG. 2 shows two concatenated systematic coders. The binary input stream is formatted into frames of K M-ary symbols, with M=2^{m}, i.e. each symbol is represented in the frame by m bits. A permutation on the K frame symbols is subsequently realized by the interleaving means. The frame of the original information symbols is supplied at the input of the first coder, while the interleaved frame is supplied at the input of the second coder. For each coder, the encoding method comprises K/k steps per frame of information symbols at the input of the encoding and modulation means. In each step, n−k redundancy symbols are generated by each coder, which yields 2n-k symbols generated in total at the start of an encoding step:

k information symbols identical to the input symbols,

n-k redundancy symbols introduced by the first coder,

n-k redundancy symbols introduced by the second coder.

These symbols are subsequently replaced by wave signals to be transmitted through the channel, in accordance with the modulation used. To improve the coder performance, particularly its spectral efficiency, marking means may be used at the output of each coder so as to suppress data in the streams of redundancy symbols. Finally, a multiplexing operation is performed for multiplexing the 3 symbol streams at the output of the encoding and modulation means.

The decoding operation is illustrated in FIG. 3. It shows an embodiment of the receiver according to the invention, comprising iterative demodulation and channel decoding means for recovering, from the received symbols, information symbols selected in a constellation having M states. The iterative demodulation and channel decoding means comprise:

means for computing the probability so as to supply probability vectors having M components, denoted Λ₀, . . . , Λ_{N′-1}, where N′ represents the number of symbols received per frame, comprising, for each received symbol, denoted r₀, . . . , r_{N-1} probability indications related to each information symbol, and probability indications related to the redundancy symbols supplied by the different coders at the transmitter end from information symbols or input symbols of the coders,

a demultiplexer for transforming the serial stream of probability vectors into three parallel streams

i. a first stream, denoted L₀^{t}, . . . , Lₖ₋₁^{t}, containing the k probability vectors comprising the probability indications related to the k information symbols of the input stream of the encoding means at the transmitter end,

ii. a second stream, denoted Lₖ^{t}, . . . , L_{N-1}^{t} containing the n-k probability vectors comprising the probability indications related to the n-k redundancy symbols generated by the first coder at the transmitter end,

iii. a third stream, denoted Lₙ^{t}, . . . , L₂ₙ₋ₖ₋₁^{t} containing the probability vectors comprising the probability indications related to the n-k redundancy symbols generated by the second coder at the transmitter end,

a sequence of decoders, referred to as SISO decoders, operating in successive pairs and receiving, at the input, at least:

i. a part of the probability vectors, and

ii. indications independent of the received symbols related to the information symbols, referred to as a priori information components, denoted A1_{iter,i}^{t} and A2_{iter,i}^{t}, respectively, iter being the iteration index and i being between 0 and k−1, for supplying, at the output, at least:

iii. results related to the information symbols, referred to as extrinsic information components, denoted E1_{iter,i}^{t} and E2_{iter,i}^{t}, respectively, and

iv. a posteriori probability indications for the information symbols, referred to as a posteriori information components, denoted APP1_{iter,i}^{t} and APP2_{iter,i}^{t} respectively,

at least a decision block, situated at the output of at least a SISO decoder, for selecting the searched information symbols from a posteriori information components supplied by the relevant decoder.

In accordance with a preferred embodiment of the invention, a pair of SISO decoders used during the iteration number i, denoted (SISO_{1,i}, SISO_{2,i}), operates in the following manner:

a first SISO decoder, denoted SISO_{1,i}, receives at the input:

i. a priori probability vectors, denoted A1_{iter,0}, . . . , A1 _{iter,k-1},

ii. probability vectors containing probability indications for received symbols corresponding to the information symbols, denoted L₀^{t}, . . . , Lₖ₋₁ₜ,

iii. probability vectors for the received symbols corresponding to first redundancy indications supplied by a first coder at the transmitter end from said information symbols, denoted Lₖ^{t}, . . . , Lₙ₋₁^{t},

and supplies at the output:

iv. first extrinsic information components denoted E1 _{iter,0}^{t}, . . . , E1_{iter,k-1}^{t} and

v. first a posteriori information components denoted APP1 _{iter,0}^{t}, . . . , APP1_{iter,k-1}^{t},

interleaving means for interleaving the first extrinsic information components (iv) and the probability indications for the received symbols corresponding to the information symbols (ii), so as to supply:

vi. first interleaved extrinsic information components and

vii. probability indications for the interleaved symbols,

a second SISO decoder, denoted SISO_{1,i}, receives at the input:

viii. the first interleaved extrinsic information components (vi) as a priori information components,

ix. said interleaved probability indications (vii),

x. probability indications for the received symbols corresponding to second redundancy indications supplied by a second coder at the transmitter end, denoted Lₙ^{t}, . . . , L₂ₙ₋ₖ₋₁^{t},

for supplying, at the output:

xi. second extrinsic information components, denoted E2_{iter,0}^{t}, . . . , E2_{iter,k-1}^{t} and

xii. second a posteriori information components denoted APP1_{iter,0}^{t}, . . . , APP1_{iter,k-1}^{t},

inverse interleaving means for de-interleaving the second extrinsic information components (xi) and the second a posteriori information components (xii) and for supplying the second extrinsic information components (xi) as a priori information components at the input of the first SISO decoder of the next pair, denoted SISO_{1,i+1}.

In accordance with this embodiment, each iteration of the decoding process consists of a processing operation by a pair of SISO decoders. The first decoder SISO_{1,1} receives predefined a priori information components A1_{1,1}^{t} to A1_{1,k}^{t} as well as the probability indications L₀^{t}, . . . , Lₖ₋₁^{t} corresponding to the information symbols, and those corresponding to the redundancy information components introduced by the first coder of FIG. 1, Lₖ^{t}, . . . , Lₙ₋₁^{t}. It supplies first extrinsic information components E1_{1,1}^{t} which are interleaved so as to be supplied at the input of the second decoder of the pair SISO_{2,1} as a priori information components. The second decoder uses these information components with the interlaced version of the probability indications L′₀^{t}, . . . , L′ₖ₋₁^{t} corresponding to the information symbols, and the probability indications Lₙ^{t}, . . . , L₂ₙ₋ₖ₋₁^{t} corresponding to the redundancy information components introduced by the second coder of FIG. 1 so as to generate second extrinsic information components E2_{1,1}^{t} which are used during the next iteration as a priori information components by the first decoder SISO_{1,2} of the next pair, after the de-interleaving operation.

De-marking means may be used for replacing the data suppressed in the marking operation performed during coding at the transmitter end. These means must be inserted at the input of the SISO decoders on the input streams containing the data Lₖ^{t}, . . . , Lₙ₋₁^{t} and Lₙ^{t}, . . . , L₂ₙ₋ₖ₋₁^{t}. If the efficiency of the coder at the transmitter end is adapted by means of a marking operation performed on the redundancy information components generated by the coders at the transmitter end, the probability indications corresponding to the redundancy information components are fixed at predefined equiprobable values.

A decision for each information symbol is taken by selecting, preferably at the start of the last iteration but in a general manner at any moment during the decoding process, i.e. at the output of a decoder having an arbitrary index it, the wave signal to be transmitted through the channel corresponding to the symbol of the M-ary constellation which has the maximum a posteriori probability according to the value of the component of the index 1 corresponding to this symbol in the a posteriori probability vector having M components APPᵢₜ, 1^{t} at the output of the relevant decoder.

FIG. 4 shows an embodiment of a SISO decoder used in the embodiment shown in FIG. 3. It comprises:

first computing means APP for supplying the a posteriori probability indications APP₀^{t}, . . . , APPₖ₋₁^{t} from probability vectors L₀^{t}, . . . , Lₖ₋₁^{t} and Lₖ^{t}, . . . , Lₙ₋₁^{t} and a priori information components A₀^{t}, . . . , Aₖ₋₁^{t}, and

second computing means EXT for supplying the extrinsic information components Ext₀^{t}, . . . , EXtₖ₋₁^{t} from a posteriori probability indications APP₀^{t}, . . . , APP^{k-1}^{t} of the a priori information components A₀^{t}, . . . , Aₖ₋₁^{t} and probability vectors comprising the probability indications related to the information symbols L₀^{t}, . . . , Lₖ₋₁^{t}.

The first computing means APP comprise:

a branch computing block, denoted BMC for computing intermediate probabilities, denoted γₜ(m′,m), from observations of the received symbols, L₀^{t} to Lₙ₋₁^{t} and a priori information components A₀^{t} to Aₖ₋₁^{t},

a computing block, denoted FA for performing a first recursion, referred to as alpha recursion or forward recursion,

a computing block, denoted BA for performing a second recursion, referred to as beta recursion or backward recursion,

a computing block, denoted AP for supplying the a posteriori information components from results supplied by the three preceding blocks.

The decoding algorithm used in accordance with this embodiment may be considered to be a generalization of the forward-backward algorithm as described in the article by L. R. Bahl, J. Cocke, F. Jelinek and J. Raviv: “Optimal decoding of linear codes for minimizing symbol error rate” published in IEEE Trans. On Information Theory, vol. 20, pp. 284-287, March 1974, which is usually applied to a binary code. There may be different variants of implementation, referred to as MAP, log-MAP or any other sub-optimal implementation of these algorithms as described, inter alia, in the article by P. Robertson, P. Hoeher and E. Villebrun: “Optimal and Sub-Optimal a Posteriori Algorithms Suitable for Turbo Decoding”, published in European Trans. On Telecommunications, vol. 8, no. 2, pp. 119-125, March-April 1997.

Modifications must be carried out on the conventional introduction of the forward-backward algorithm which applies to decoding of a binary convolute code. Modifications are performed upstream:

in the computation of probabilities of the received symbols,

in the computation of the transition metrics between states from probabilities of the received symbols and from a priori probabilities of the information symbols.

The forward-backward algorithm, or one of its sub-optimal logarithmic variants is subsequently applied in the conventional manner.

Other notable differences with respect to the conventional introduction of the forward-backward algorithm occur downstream:

in the computation of the a posteriori probabilities of the information symbols,

in the computation of the extrinsic information components of the information symbols.

These differences are explained below by using the notations in the article by L. R. Bahl, J. Cocke, F. Jelinek and J. Raviv. The computation of the probabilities of the received symbols is performed by a demodulator, referred to as soft demodulator, which realizes the interface between the output of the channel and the start of the iterative turbo decoding operation. The soft demodulator is illustrated in FIG. 3 by the probability computing means. The soft demodulator computes the probability indications for the symbols. For the received symbol Yᵢ^{t}, this probability indication is a vector having M components:

Lᵢ^{t}={R(Yᵢ^{t}/X₁), . . . ,R(Yᵢ^{t}/X_{M})} (1)

wherein Xₘ, m∈{1, . . . M} corresponds to each symbol in the constellation. In accordance with the forward-backward algorithm or one of its variants used, the demodulator computes the probabilities in a different way.

In the non-logarithmic case, the probabilities are defined by:

R(Yᵢ^{t}/Xₘ)=Pr{Yᵢ^{t}/Xₘ} (2)

This quantity only depends on characteristics supposed to be known for the channel. In the case of a channel with additive white Gaussian or AWGN noise, it is expressed by:

$$R ( {Y}_{i}^{t} / {X}_{m} ) = \frac{1}{{( \sqrt{2 {πσ}^{2}} )}^{dim}} \cdot exp ( - \frac{1}{2 {σ}^{2}} {‖ {Y}_{i}^{t} / {\tilde{X}}_{m} ‖}^{2} ) \qquad ( 3 )$$

where σ² represents the noise variants, dim the modulation dimension, \tilde{X}ₘ the transmitted signal corresponding to the symbol Xₘ, and ∥ • ∥ the norm.

During the computation, a normalization operation is added:

$$\hat{R} ( {Y}_{i}^{t} / {X}_{m} ) = \frac{R ( {Y}_{i}^{t} / {X}_{m} )}{{\sum }_{{m}^{′}} R ( {Y}_{i}^{t} / {X}_{{m}^{′}} )} \qquad ( 4 )$$

which allows it to be freed from the constant coefficient.

In the case of a logarithmic version of the forward-backward algorithm (logMAP, MaxlogMAP, or Corrective MaxlogMAP), the probabilities are defined by:

R(Yᵢ^{t}/Xₘ)=log(Pr{Yᵢ^{t}/Xₘ}) (5)

For a AWGN channel, by taking into account the use which is made of the probabilities per algorithm (in the computation of the branch metrics), it is possible to reduce the expression to

$$R ( {Y}_{i}^{t} / {X}_{m} ) = \frac{1}{{σ}^{2}} ( 2 \cdot ⟨ {Y}_{i}^{t} , {X}_{m} ⟩ - {‖ {\tilde{X}}_{m} ‖}^{2} ) \qquad ( 6 )$$

where [symbol] • [symbol] represents the scalar product. In the case of a constant energy modulation, the probabilities may be computed by means of the following equation:

$$R ( {Y}_{i}^{t} / {X}_{m} ) = \frac{2}{{σ}^{2}} ⟨ {Y}_{i}^{t} , {\tilde{X}}_{m} ⟩$$

The computation of the transition metrics between states γₜ(m,m′) from probabilities of the received symbols and a priori probabilities of the information symbols must also be adapted to the case of M-ary symbols. The transition metric at the instant t between the states m and m′ is described in the non-logarithmic case:

$${γ}_{t} ( m \text{;} {m}^{′} ) = {p}_{t} ( m / {m}^{′} ) {\prod }_{i = 1}^{n} R ( {Y}_{i}^{t} / {X}_{i} ( m \text{;} {m}^{′} ) ) \qquad ( 7 )$$

where X_{i(m;m′)} corresponds to the ith symbol generated by the coder during a transition between the state m and the state m′, and Yᵢ^{t} to its corresponding observation for the instant i. It is to be noted that each product term is the component having the index i(m;m′) of the probability vector Lᵢ^{t}. The a priori probability of the transition of the state Sₜ₋₁=m′ to the state Sₜ=m is expressed as such by

$${p}_{t} ( m / {m}^{′} ) = Pr \{ {S}_{t} = m / {S}_{t - 1} = {m}^{′} \} = {\prod }_{i = 1}^{k} A ( {X}_{i}^{t} = {X}_{i} ( m \text{;} {m}^{′} ) ) \qquad ( 8 )$$

where A(Xᵢ^{t}=X_{i(m;m′)}) is the a priori probability, with the information symbol Xᵢ^{t} being equal to the corresponding symbol of the transition between m and m′. It is to be noted that each product term is the component of the index i(m;m′) of the a priori probability vector of Xᵢ^{t}:Aᵢ^{t}.

When using a logarithmic version of the algorithm, all the products in the equations (7) and (8) are to be replaced by sums.

The forward-backward algorithm, or one of its variants, is then applied in a conventional manner, with the branch metrics being adapted to the case where the binary data are replaced by symbols as described in the equations (7) and (8). The algorithm comprises three steps, similarly as in the article by L. R. Bahl, J. Cocke, F. Jelinek and J. Raviv:

a step “go” allowing computation of the αₜ(m)=Pr{Sₜ=m;Y₁^{t}}

a step “return” allowing computation of the βₜ(m)=Pr{Yₜ₊₁^{T}/Sₜ=m}

a computation, from α, β and γ, of σ which are values proportional to the a posteriori probabilities of the transitions:

σₜ(m,m′)=Pr{Sₜ₋₁=m;Sₜ₋₁=m′;Y}=αₜ₋₁(m′).γₜ(m,m′).βₜ(m) (9)

where Y designates any observation at the output of the channel.

The a posteriori probability computation of the information symbols is performed on the basis of these quantities. The a posteriori probability vector of the information symbol Xᵢ^{t} is written as:

APPᵢ^{t}={Pr(Xᵢ^{t}=X₁/Y), . . . , Pr(Xᵢ^{t}=X_{M}/Y)} (10)

Each of these terms is expressed by:

$$Pr \{ {X}_{i}^{t} = {X}_{j} / Y \} = {\sum }_{{m}^{′} , m / {X}_{i}^{t} = {X}_{j}} {σ}_{t} ( m , {m}^{′} ) = {\sum }_{{m}^{′} , m / {X}_{i}^{t} = {X}_{j}} {α}_{t - 1} ( {m}^{′} ) \cdot {γ}_{t} ( m , {m}^{′} ) \cdot {β}_{t} ( m ) \qquad ( 11 )$$

wherein the sum is taken for all the transitions of the states m to the states m′ at the instant t at which the value Xⱼ of the information symbol occurs at the position i.

The computation of extrinsic information components of each information symbol may be performed in parallel with the a posteriori probability computation on the same symbol by ignoring in the branch metrics γₜ(m,m′), considered in equation (11), the terms corresponding to the a priori probability and the probability of the information symbol considered. The extrinsic information vector of the information symbol Xᵢ^{t} is written as:

Extᵢ^{t}={Ext(Xᵢ^{t}=X₁), . . . , Ext(Xᵢ^{t}=X_{M})} (12)

Each of these terms can be advantageously computed by introducing the term [symbol] ₜⁱ(m,m′), which corresponds to the branch metric that contains neither the a priori nor the probability of Xᵢ^{t}:

$${\hat{γ}}_{t}^{i} ( m \text{;} {m}^{′} ) = {\prod }_{j = 1 , j \neq i}^{k} A ( {X}_{i}^{t} = {X}_{j} ( m \text{;} {m}^{′} ) ) {\prod }_{j = 1 , j \neq i}^{n} R ( {Y}_{j}^{t} / {X}_{j} ( m \text{;} {m}^{′} ) ) \qquad ( 13 )$$

By virtue of this quantity, the extrinsic information components can be computed by:

$$Ext ( {X}_{i}^{t} = {X}_{j} ) = {\sum }_{{m}^{′} , m / {X}_{i}^{t} = {X}_{j}} {α}_{t - 1} ( {m}^{′} ) \cdot {\hat{γ}}_{t} ( m , {m}^{′} ) \cdot {β}_{t} ( m ) , \qquad ( 14 )$$

Normalization operations which are similar to equation (4) are performed on the a posteriori probability vectors and on the extrinsic information vectors:

$$\hat{APP} ( {X}_{i}^{t} = {X}_{u} ) = \frac{APP ( {X}_{i}^{t} = {X}_{u} )}{{\sum }_{v} {APP}_{t} ( {X}_{i}^{t} = {X}_{v} )} , et \hat{Ext} ( {X}_{i}^{t} = {X}_{u} ) = \frac{Ext ( {X}_{i}^{t} = {X}_{u} )}{{\sum }_{v} {Ext}_{t} ( {X}_{i}^{t} = {X}_{v} )} \qquad ( 15 )$$

It is to be noted that the generalization of the decoding operation at the soft input and output of a binary convolute code with respect to a code for the symbols does not involve any modification of the MAP algorithm or of its sub-optimal variants. The inputs and the outputs of the algorithms need only be adapted to vectorial data corresponding to all the possible values of the symbols. Particularly, the conventional techniques of initializing “alpha” and “beta” quantities of the algorithm are valid, when coding without trellis, with zero setting of the final state, or tail-biting is concerned.

During the first decoding iteration, the first SISO decoder does not have information on the a priori probabilities of the information symbols. The vectors Aᵢ^{t} are thus initialized in the following manner:

in the case of a non-logarithmic introduction:

∀i, ∀t, Aᵢ^{t}={1/M, . . . ,1/M} (16)

where M is the cardinal number for the alphabet of the symbols

in the case of a logarithmic introduction:

∀i, ∀t, Aᵢ^{t}={log(1/M), . . . , log(1/M)} (17)

Embodiments of a transmitter, a receiver, an encoding method and a decoding method, a computer program and a signal, all adapted to modulations having a large number of states for improving the performances at the channel decoding level have been described hereinbefore. Other embodiments may easily be derived from the embodiments described without passing beyond the scope of the invention. Particularly, the invention is not limited to the modulations described with reference to the embodiments.

1. A transmitter comprising channel encoding and modulation means for transforming a binary data stream into wave signals represented by symbols to be transmitted and intended to transport said binary data in a transmission channel, said wave signals being selected in a constellation having M states, characterized in that said channel encoding and modulation means comprise:
conversion means upstream for converting said binary data stream into a stream of information symbols, referred to as input stream, such that the number of possible information symbols is equal to the number M of states of said constellation,
interleaving means for interleaving said information symbols of the input stream and generating a stream of interleaved information symbols, referred to as interleaved input stream,
at least a first and a second coder operating in parallel for receiving said input stream and said interleaved input stream, respectively, for supplying output streams comprising:
i indications relating to said information symbols and first redundancy information components introduced by the first coder, and
ii. second redundancy information components introduced by the second coder,
selection means for determining, from said output streams, said wave signals to be transmitted.

2. A transmitter as claimed in claim 1, wherein said conversion means comprise a correspondence table for converting a sequence of m bits in the binary data stream, with m=log₂(M) into an information symbol selected from the M possible information symbols.

3. A transmitter as claimed in claim 1 or 2, wherein said first and second coders have an encoding efficiency, denoted k/n an k′/n′, respectively, k and k′ being integers representing a number of information symbols processed in parallel at the input of the coder, n and n′ being integers representing numbers of encoded symbols supplied in parallel at the output of the coder, respectively, such that k=k′.

4. A receiver comprising iterative demodulation and channel decoding means for recovering, from received signals, information symbols selected in an alphabet having M states, characterized in that said iterative demodulation and channel decoding means comprise:
reception means for receiving said signals and converting them into data symbols, referred to as received symbols,
probability computation means for supplying probability vectors comprising, for each received symbol, probability indications relating to said information symbols and probability indications relating to redundancy indications supplied by a coder at the transmitting end from said information symbols,
a sequence of decoders, referred to as SISO decoders, operating in successive pairs and receiving, at the input, at least:
v. said probability vectors, and
vi. independent indications of the received symbols related to the information symbols, referred to as a priori information components,
for supplying, at the output, at least:
vii. results related to the information symbols, referred to as extrinsic information components, and
viii. a posteriori probability indications for the information symbols, referred to as a posteriori information components,
at least a decision block for selecting said information symbols from said a posteriori information components.

5. A receiver as claimed in claim 4, wherein the SISO decoders comprise:
first computation means for supplying said a posteriori probability indications from said probability vectors and said a priori information components, and
second computation means for supplying said extrinsic information components from said a posteriori probability indications, said a priori information components and said probability vectors comprising the probability indications relating to said information symbols.

6. A receiver as claimed in claim 4 or 5, wherein a pair of SISO decoders comprises:
a first SISO decoder for receiving, at the input:
i said a priori information components,
ii. probability indications for received symbols corresponding to said information symbols,
iii. probability indications for received symbols corresponding to first redundancy indications supplied by a first coder at the transmitter end from said information symbols,
and for supplying, at the output, first extrinsic information components and first a posteriori information components,
interleaving means for interleaving said first extrinsic information components and said probability indications for the received symbols corresponding to the information symbols so as to supply first interleaved extrinsic information components and interleaved probability indications,
a second SISO decoder for receiving, at the input:
i. said first interleaved extrinsic information components as a priori information components,
ii. said interleaved probability indications,
iii. probability indications for received symbols corresponding to second redundancy indications supplied by a second coder,
for supplying, at the output, second extrinsic information components and second a posteriori information components,
inverse interleaving means for de-interleaving the second extrinsic information components and the second a posteriori information components and for supplying said second extrinsic information components as a priori information components at the input of the first SISO decoder of the subsequent pair.

7. A transmission system comprising a transmitter as claimed in any one of claims 1 to 3 and a receiver as claimed in any one of claims 4 to 6.

8. A method of channel encoding and modulation for transforming a binary data stream into wave signals represented by symbols to be transmitted and intended for transporting said binary data in a transmission channel, said wave signals being selected in a constellation having M states, characterized in that said method comprises the steps of
converting upstream said binary data stream into a stream of information symbols, referred to as input stream, such that the number of possible input symbols is equal to the number M of states of said constellation,
interleaving said input stream and deriving an interleaved input stream therefrom,
encoding, with the aid of at least a first and a second coder operating in parallel, for receiving said input stream and said interleaved input stream, respectively, and for supplying output streams comprising indications relating to said information symbols and first redundancy information components introduced by the first coder, and second redundancy information components introduced by the second coder,
selecting for determining, from said output streams, the symbols to be transmitted.

9. An iterative method of demodulation and channel decoding for recovering transmitted information symbols selected in an alphabet having M states from received signals, characterized in that said method comprises the steps of
receiving said signals and converting them into data symbols, referred to as received symbols,
probability computation for supplying probability vectors comprising, for each received symbol, probability indications relating to said information symbols and probability indications relating to redundancy indications supplied by a coder at the transmitter end from said information symbols,
iterative decoding, each iteration comprising:
i. a first sub-step of decoding for supplying:
(a) results relating to the information symbols, referred to as first extrinsic information components, and
(b) a posteriori probability indications for the information symbols, referred to as first a posteriori information components, from:
(c) said probability vectors, and
(d) independent indications of the received symbols, relating to said information symbols, referred to as a priori information components,
ii. a step of interleaving said first extrinsic information components and said probability vectors comprising the probability indications for the received symbols corresponding to the information symbols so as to supply first interleaved extrinsic information components and interleaved probability indications,
iii. a second decoding sub-step for supplying second extrinsic information components and a posteriori probability indications for the received symbols, referred to as second a posteriori information components, from said first interleaved extrinsic information components, used as a priori information components, and from said interleaved probability indications,
iv. an inverse interleaving step for de-interleaving the second extrinsic information components and the second a posteriori information components and for supplying said second extrinsic information components as a priori information components at the input of the first decoding sub-step of the subsequent iteration,
a decision step for selecting information symbols from said a posteriori information components.

10. A computer program comprising program code instructions for performing a method as claimed in claim 8 or 9.

11. A signal for transporting a computer program as claimed in claim 10.
